(19) United States
(12) Patent Application Publication
(10) Pub. No.: US 2015/0286241 A1
(43) Pub. Date: Oct. 8, 2015

(54) VIDEO FADER HANDLES AND RELATED METHODS

(71) Applicant: ROSS VIDEO LIMITED, Iroquois (CA)

(72) Inventors: Donald Michael Douglas LOCKE, Smiths Falls (CA); Seaho SONG, Kanata (CA); Trevor Charles MAY, Ottawa (CA); David Allan ROSS, Nepean (CA); Leslie Vincent O'REILLY, Ottawa (CA); Alun John FRYER, Stittsville (CA)

(21) Appl. No.: 14/570,050

(22) Filed: Dec. 15, 2014

Related U.S. Application Data
(60) Provisional application No. 61/976,093, filed on Apr. 7, 2014.

(51) Int. Cl. G05G 1/06; H04N 5/262

(52) U.S. Cl. CPC G05G 1/06; H04N 5/262

(57) ABSTRACT

Lever handles for video fader consoles are disclosed. A lever handle is used to control transition of video segments in a video production system. A hand grip of the lever handle is parallel to the video fader console in an embodiment, and could be made to fit a user's hand such that a user can completely grasp the hand grip with all fingers. The lever handle includes the hand grip and an arm structure which offsets the hand grip thereby permitting a user to grasp the hand grip without any impedance from the arm structure, which could provide greater operator control of the handle during operation. Embodiments with adjustable handle length or height are also disclosed.

### CROSS-REFERENCE TO RELATED APPLICATIONS

The present application is related to, and claims the benefit of, U.S. Provisional Application Ser. No. 61/976,093, filed on Apr. 7, 2014, the entire contents of which are incorporated herein by reference.

### FIELD OF THE INVENTION

The present disclosure relates to a fader system for use in video production and more specifically to a video fader handle and related methods.

### BACKGROUND

Fader consoles used in video production systems generally include either a T-bar type handle or slider bars to transition from one video frame or scene to the next. The T-bar handle requires a user to either awkwardly wrap his or her fingers around the bar with a portion of the bar arm squeezed in between the fingers, or the user may prefer to use his/her palm to push the bar backwards or forwards.

With slider bars, a user is required to use his or her fingertips to move the slider either up or down. Only the user's fingertips are used to control transitions.

In certain applications, it may be desirable to minimize the height of the fader handle in order to facilitate storage. This is particularly important when a video fader console is stored in a case for storage or transit, or combined with other equipment in a “flight pack”. However, a lower profile fader handle results in a shorter shaft, and shorter throw of the fader.

### BRIEF SUMMARY

According to an aspect of the present disclosure, a lever handle for a video fader console includes a hand grip and an arm. The arm includes: a first section to be coupled to the video fader console; a second section coupled to the hand grip; and a third section coupled to the first section and to the second section to offset the first section out of alignment with the second section. The hand grip is offset from the third section by the second section, in a direction away from the first section.

The first section could include a first end, and a second end that is to be coupled to the video fader console. The second section could include a first end coupled to the hand grip, and a second end. The third section could include a first end coupled to the first end of the first section and a second end coupled to the second end of the second section to orient the first section and the second section to extend in parallel directions.

In an embodiment, the arm causes the hand grip to be oriented parallel to a surface of the video fader console.

The hand grip could be coupled to the second section by a fastener.

The second section is perpendicular to the hand grip in some embodiments.

The hand grip could be adjustably positionable on opposite sides of the second section.

In an embodiment, the first section includes a shaft of a T-bar handle, the third section includes a hand grip of the T-bar handle, and the second section includes an extension coupled to an end of the hand grip of the T-bar handle. The hand grip of the lever handle could have a first end and a second end, in which case the second section could include a first end coupled to the first end of the hand grip of the lever handle, and a second end coupled to the end of the hand grip of the T-bar handle. The hand grip of the T-bar handle could have a second end, and the arm could include a second extension with a first end, coupled to the second end of the hand grip portion of the lever handle, and a second end, coupled to the second end of the hand grip portion of the T-bar handle.

In another embodiment, the hand grip has a first end, coupled to the first end of the second section, and a second end, and the arm also includes: a fourth section with a first end, coupled to the second end of the hand grip, and a second end; and a fifth section with a first end coupled to the first end of the first section and a second end coupled to the second end of the fourth section.

The third section could further offset a center of the hand grip out of alignment with the first section.

The arm could include a length adjuster, which has at least a first position in which the arm has a first length, and a second position in which the arm has a second length shorter than the first length. The length adjuster could include one of: a telescoping mechanism, a releasable attachment, and a folding mechanism.

A video fader console could include a lever handle as described above.

A method in accordance with another aspect of the present disclosure involves: providing a hand grip for a video fader console lever handle; and providing an arm for the video fader console lever handle. The arm includes: a first section to be coupled to the video fader console; a second section to be coupled to the hand grip; and a third section coupled to the first section and to the second section to offset the first section out of alignment with the second section. The hand grip is offset from the third section by the second section, in a direction away from the first section.

As noted above, the first section could include a first end, and a second end that is to be coupled to the video fader console; the second section could include a first end to be coupled to the hand grip, and a second end; and the third section could include a first end and a second end. Providing the arm portion could then involve: providing the first section, the second section, and the third section; coupling the first end of the third section to the first end of the first section; and coupling the second end of the third section to the second end of the second section.

The method could also include coupling the hand grip to the first end of the second section.

Providing an arm could include providing at least one of the first section and the second section with a height adjuster.

In another aspect, a lever handle for a video fader console includes an arm to be coupled to the video fader console and a hand grip coupled to the arm. The arm includes a length adjuster having at least a first position in which the arm has a first length, and a second position in which the arm has a second length shorter than the first length.

The height adjuster includes a telescoping mechanism in an embodiment. The height adjuster could also or instead include a releasable attachment. In another embodiment, the height adjuster includes a folding mechanism.

The foregoing and additional aspects and embodiments of the present disclosure may be or become apparent to those of ordinary skill in the art in view of the detailed description of various embodiments and/or aspects, which is made with reference to the drawings, a brief description of which is provided next.

### BRIEF DESCRIPTION OF THE DRAWINGS

Examples of embodiments will now be described in greater detail with reference to the accompanying drawings.

FIG. 1 illustrates an embodiment of a fader console.

FIG. 2A is a perspective view of the video fader handle of FIG. 1.

FIG. 2B is another perspective view of the video fader handle of FIG. 1.

FIG. 3A is a plan view of the video fader handle of FIG. 1.

FIG. 3B is another plan view of the video fader handle of FIG. 1.

FIG. 4 illustrates another example video fader handle.

FIGS. 5A and 5B are plan views of an example video fader handle with a length adjuster.

FIGS. 6A and 6B are plan views of another example video fader handle with a length adjuster.

FIG. 7 is a top view of an example video production switcher panel.

FIG. 8 is a flow diagram of an example method.

### DETAILED DESCRIPTION

The design of a T-bar video fader handle can impede a user from gripping the bar in a natural manner and can make it difficult for the user to precisely control the handle movements. With slider bars, a user is required to use his or her fingertips to move the slider either up or down. As with the T-bar type handle, the user might not have as much control of the slider because only the user's fingertips are used to control transitions. Both of these handle types can result in poor transitions, mis-timing and other mistakes.

As noted above, although it may be desirable to minimize the height of a fader handle in order to facilitate storage, a lower profile fader handle results in a shorter shaft, and shorter throw of the fader. This can be less comfortable, make control less precise, and make the fader handle more difficult to grasp than a fader handle with a normal or longer shaft.

The present disclosure provides various embodiments of a lever handle for a video fader console used in video production systems. The embodiments include embodiments of an ergonomic video fader handle in which a hand grip is offset from an arm of the handle, and embodiments with adjustable length or height.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the scope of an invention as defined by the appended claims. Example embodiments will now be described with reference to the figures provided.

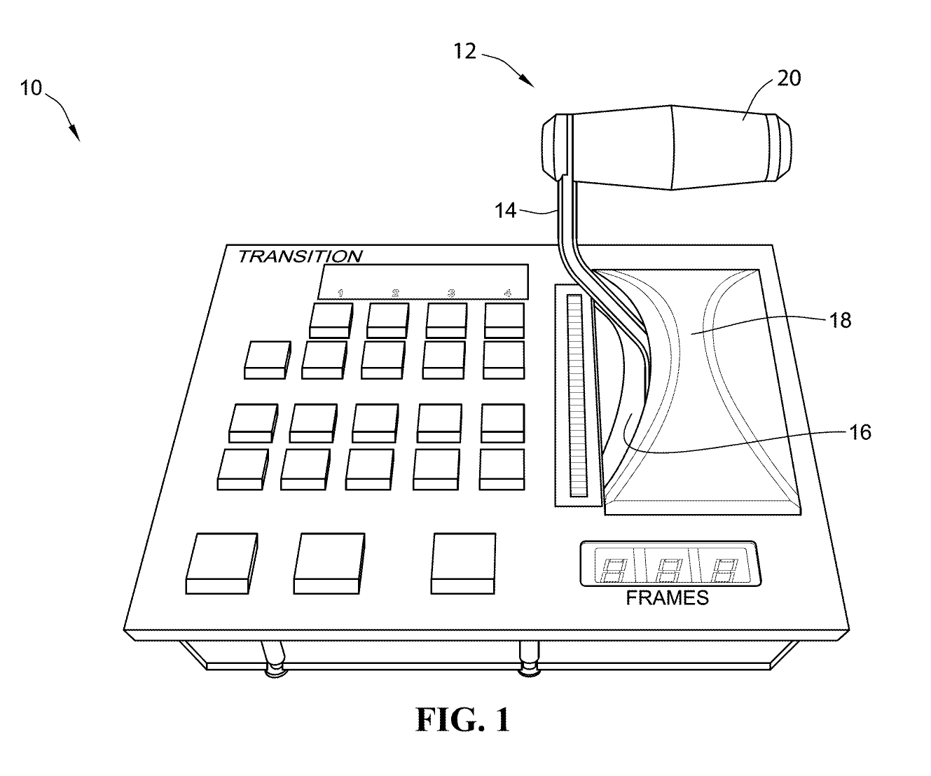

FIG. 1 illustrates an embodiment of a video fader console 10 with an ergonomic fader handle. The example ergonomic fader handle includes a mechanical lever handle 12 having a hand grip portion 20 that is parallel in orientation to a front or top surface of the video fader console 10. The lever handle 12 includes the hand grip portion 20, also referred to herein as a hand grip, and a curved arm portion 14, also referred to herein as an arm or shaft, which attaches to the video fader console 10. The lever handle could attach to a rotational mechanism inside the video fader console 10, for example, which may contain belts, gears, and/or other mechanical features. Physical position of the lever handle 12 could be measured from a point of rotation of such a rotational mechanism and translated into an electrical signal.

The hand grip portion 20 is generally perpendicular to the curved arm portion 14 and the arm portion 14 supports the hand grip portion 20 and passes into a sleeve portion or boot 18 which covers a handle track 16 and a lower section of the curved arm 14. In the example shown, the hand grip portion 20 is generally cylindrical but has non-cylindrical surfaces. However, a longitudinal axis of the hand grip portion 20 is parallel to a top surface of the fader console 10 and perpendicular to an upper portion of the curved arm 14 in the example shown. In this sense, even though the hand grip portion 20 might include surfaces that are not necessarily parallel to the video fader console 10 and/or perpendicular to the curved arm 14, the hand grip portion can still be considered to be parallel to the video fader console 10 and perpendicular to at least a portion or section of the curved arm 14.

The lever handle 12 is used to control transition of video segments in a video production system. The lever handle 12 operates by being grasped by the console user and pushed forward or pulled backward. The lever handle 12 slides along a track 16 in the example shown. The track 16 is covered by a sleeve or boot 18 which keeps the inside of the track and the rotational mechanism (not shown) within the video fader console 10 clear of debris. The motion of the lever handle 12 sliding forward or backward corresponds to the speed at which the video segments are to be transitioned. This is a delicate procedure and entails a high level of precision by the user of the video fader console 10.

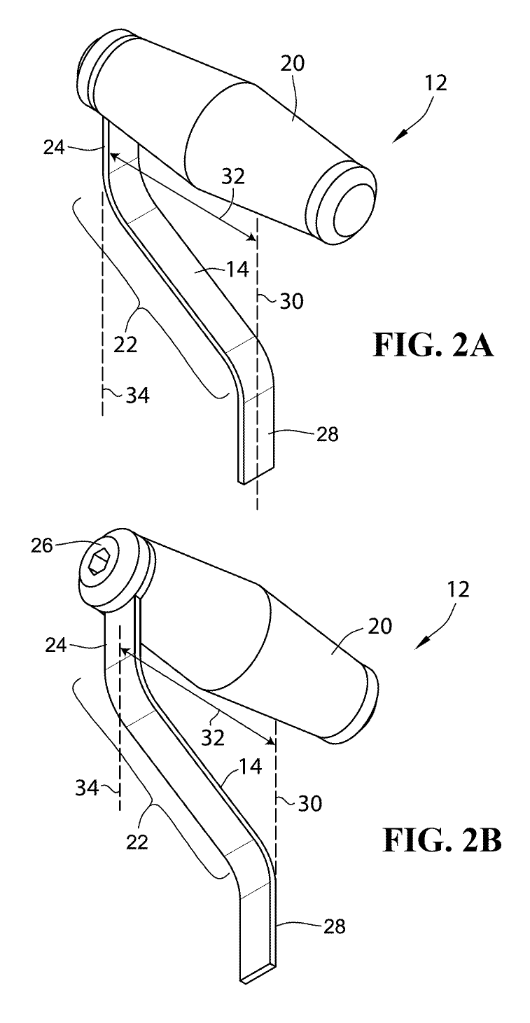

FIGS. 2A and 2B are perspective views of the example video fader handle of FIG. 1. The hand grip portion 20 of the embodiment shown is physically offset from the curved arm portion 14, meaning that a user of the fader console 10 (FIG. 1) can fully grip the hand grip portion 20 of the lever handle 12 without obstruction or impedance from the curved arm portion 14 of the lever handle 12 due to the offset provided by the curved arm 14.

The curved arm portion 14 has a structure including two straight sections 24, 28 which in the embodiment shown are parallel to each other. One of the straight sections 24 is connected to the hand grip 20 by means of a fastener 26. The straight section 24 is perpendicular in orientation to the hand grip portion 20. The curved arm 14 also includes a curved middle section 22 between the two straight sections 24, 28. The straight section 24 connects to both the hand grip portion 20 and a top end of the curved middle section 22. The other straight section 28 of the arm structure is attached to the bottom of the curved section 22 and at its base to the video fader console, to a rotational assembly in the video fader console for example. The two straight sections 24, 28 are perpendicular to the hand grip portion 20 in the example shown.

The combination of the curved and straight sections forms a distinct curve in the curved arm 14 which creates an offset from the base of the arm to the hand grip portion 20. This offset of the curved arm 14 may allow the operator more control of the hand grip portion 20 by providing enough space to grip the lever handle 12 between the hand grip portion 20 and the curved arm 14 and therefore better control of the handle itself. It should be appreciated that the lever handle 12 does not in any way preclude a user from employing other handle control techniques such as previously-learned “fingertip” control of a fader handle. Thus, an ergonomic lever handle such as the lever handle 12 in accordance with embodiments of the present disclosure might allow for a user to use their palm, fingertips, or full enclosed grip of the handle, for example. Such an ergonomic lever handle could therefore add new ways to grip a fader handle, but old control techniques could still be used with a new handle design.

FIGS. 2A and 2B also show another representation of arm section offset. In the example lever handle 12, the arm 14 could be considered as having a straight section 28 to be coupled to the video fader console 10. In FIG. 1, this portion is inside the boot 18. The other straight section 24 is coupled to the hand grip 20. The curved section 22 is coupled to the section 28 and to the section 24, to offset one of these sections out of alignment with the other.

The dashed line 30 in FIGS. 2A and 2B is in alignment with the section 28, and the dashed line 34 is similarly in alignment with the section 24. The offset of the section 28 and the section 24 out of alignment with each other is shown at 32. In the example shown, the sections 24, 28 extend in parallel directions, and the offset 32 is perpendicular to the parallel directions. Even though the section 22 is not itself perpendicular to the sections 24, 28 in this example, it still offsets the section 28 and the section 24 from each other in a perpendicular direction. The offset could have perpendicular and parallel components as in the example shown, and therefore the section 22 could be considered to offset the section 28 and the section 24 from each other at least in a direction perpendicular to the parallel directions 30, 34 in which those sections extend. In FIGS. 2A and 2B, the directions 30, 34 are perpendicular to the hand grip 20, and in this case the offset 32 is also parallel to the hand grip 20.

It should be appreciated that straight sections that extend in parallel but offset directions as shown in FIGS. 1 to 2B represent an illustrative, non-limiting example. Arm sections need not be parallel, or even straight, in other embodiments.

Another offset that is provided by the example lever handle 12 is the offset of the hand grip 20 from the section 22. This offset is provided by the section 24, and the offset of the hand grip 20 from the section 22 is in a direction away from the section 28. In the example shown, the section 28 is at one side of the section 22, and the hand grip 20 is at an opposite side of the section 22. The length of the section 24 sets the amount of offset between the hand grip 20 and the section 22. Since the section 24 extends from the section 22 on the opposite side of the section 22 from the section 28, the offset between the hand grip 20 and the section 22 is in a direction away from the section 28.

In the example video fader handle of FIGS. 2A and 2B, the section 28 has two ends. One end is coupled to the section 22, and the other end is to be coupled to the video fader console 10, such as to a rotational mechanism in the video fader console. The section 24 also has two ends, with one end coupled to the hand grip 20 and the other coupled to the section 22. Like the other sections of the arm 14, the section 22 also includes two ends, with one end coupled to the section 28 and the other end coupled to the section 24. A result of coupling the sections together in the manner shown in FIGS. 1 to 2B is that the section 22 orients the section 28 and the section 24 to extend in parallel directions, as shown at 30 and 34 in FIGS. 2A and 2B.

Regardless of whether the curved corners of the arm 14 in FIGS. 1 to 2B are considered to be the ends of the sections 24, 28 or ends of the section 22, in either case the sections 24, 28 are oriented to extend in parallel directions 30, 34. The offset 32 between the sections 24, 28 in FIGS. 2A and 2B is then also perpendicular to the parallel directions.

The arm 14, when attached to the video fader console 10, causes the hand grip 20 to be oriented parallel to a top surface of the video fader console. However, other orientations are possible in different embodiments.

In a conventional T-bar handle, the hand grip is centered over the shaft. In some embodiments of a lever handle such as the lever handle 12 in FIGS. 1 to 2B, the arm section 22 further offsets a center of the hand grip 20 out of alignment with the section 28. The hand grip 20 could be, but need not be, centered over the section 28 which couples to the fader console 10.

The various offsets described herein may be varied by changing lengths of arm sections, one or more angles between pairs of arm sections, and/or the length of the hand grip, for example. In general, the arm sections 22, 24, 28 and/or the hand grip 20 may be sized and arranged to position parts of a lever handle in any of various desired locations, relative to each other or relative to the video fader console 10.

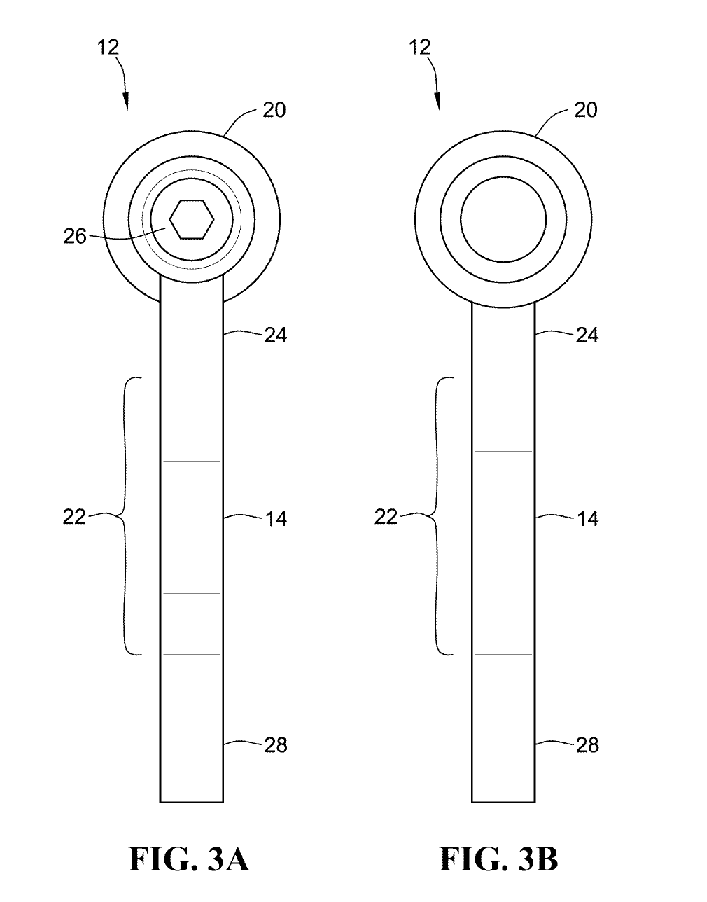

FIGS. 3A and 3B show opposite plan views of the video fader handle of FIG. 1 including a fastener 26 which connects the curved arm 14 to the hand grip portion 20. The fastener 26 can be, for example, a bolt or a screw. It should be noted however, that other methods of connecting the hand grip 20 to the arm 14 are possible and remain within the scope of the embodiment.

In another embodiment, the hand grip portion 20 is made to fit a user's hand so that a user can completely grasp the hand grip portion with all fingers. The hand grip portion 20 could also or instead be made of a material that is durable enough to compensate for the offset of the handle and can endure high levels of applied force during both routine operation and servicing of the fader console. The hand grip portion 20 and/or material forming the hand grip portion could be constructed such that the weight of the hand grip is balanced evenly on the curved arm 14. This could be useful in providing greater operator control or better “feel” of the lever handle 12 during operation.

While the hand grip portion 20 is shown in the figures to be cylindrical in shape having a smooth surface, it should be noted that other shapes and textures may be used while remaining within the scope of the invention. For example, the hand grip portion 20 could be round to form a spherical or ball like shape, it could contain ridges and/or grooves to accommodate the user's fingers and thereby possibly make it easier for the console user to grasp the hand grip portion, and/or it could be ribbed and/or roughened to create a non-slip or slip resistant surface.

In yet another embodiment the hand grip portion 20 points outwards in relation to the curved arm 14 and the console 10 in the opposite direction shown in the figures. With this orientation, the user can still grasp the hand grip portion 20 in the same manner as the above described embodiments, including the same ease of control and operation of the lever handle 12. However, the curved arm 14, track 16 and sleeve or boot 18 could be reversed, away from the console 10 and therefore can provide a slightly improved view of the panel from the user's perspective.

The embodiment shown in FIG. 1, the lever handle is positioned on a right-hand side of the video fader console 10. In another embodiment, the lever handle 12 is located on the opposite left-hand side of the console 10, to accommodate left handed users for example.

The orientation of the arm 14 and hand grip 20 could also or instead be reversed, so that the arm exits the right-hand side of the boot 18 and the hand grip projects from the left-hand side of the arm.

The hand grip 20 could be pivotably connected to the curved arm 14 in some embodiments. In order to enable the hand grip 20 to be adjustably positionable on opposite sides of the curved arm 14, for example, the hand grip could be pivotable over an end of the curved arm 14. The user could then pivot the hand grip 20 to either side of the curved arm 14 without relocating the curved arm and/or the sleeve or boot 18.

The curved arm 14 could have curves with larger or smaller radii than shown in the drawings. Sections of the curved arm 14 could be connected at right angles or larger angles.

Another possible variation could involve providing multiple arms which respectively connect to the lever handle 12. A generally Y-shaped arm, for example, could have multiple arm sections 22, 24 connecting to a single arm section 28 and opposite ends of the hand grip portion 20. Thus, in an embodiment, the hand grip has two ends. One end is coupled to an end of the section 24, as shown in FIGS. 2A and 2B. The arm could also include another section like the section 24, but coupled to the other end of the hand grip 20, and another section like the section 22 coupled to the section 28 but extending in an opposite direction. These additional sections could be coupled together like the sections 24, 22, to form a Y-shaped arm.

This type of arrangement would provide central shaft design similar to a T-bar handle, but with an open area below the hand grip portion 20 to accommodate a user's fingers and/or thumb. With a right-angle junction between a central shaft 28 and the upper arms in this type of design, an ergonomic handle could be similar to a T-bar handle but with extensions at the “top” of the T-bar shaft.

An ergonomic handle as disclosed herein could be provided as an original handle that is incorporated into a fader console or module. In some embodiments, an existing fader console or module with a T-bar handle could be retrofitted with an ergonomic handle.

Retrofitting could involve replacing a T-bar handle and its sleeve or boot with an ergonomic handle such as the lever handle 12 and a corresponding sleeve or boot 18. Another possible option could involve removing the hand grip portion from the top of a T-bar handle, by cutting the handle shaft or otherwise removing the hand grip, and attaching an ergonomic handle to the existing handle shaft. This connection could be a bonded connection by welding, adhesive, and/or other bonding technique, a fastener connection through one or more screws, rivets, bolts with or without nuts, or other type of fastener, and/or a friction fit connection by providing a pocket or other structure at the console end of the ergonomic handle to receive a top portion of the existing handle shaft.

Another possible retrofit option could involve attaching an extension at one or both ends of an existing T-bar hand grip portion and a second parallel handle grip portion above the T-bar handle. With an extension at each end of a T-bar hand grip portion, for example, there would be an existing T-bar handle, an extension at each end of the hand grip portion, and a second hand grip portion offset from the existing T-bar handle. An open rectangular area would then be provided between the hand grip portions for accommodating a user's fingers and/or thumb. The two hand grip portions would form two parallel sides of the open rectangular area, and the two extensions would form the other two parallel sides of the open rectangular area. Any of various types of connections could be provided between an extension and each hand grip portion to enable operation of a fader console using the extended hand grip portion.

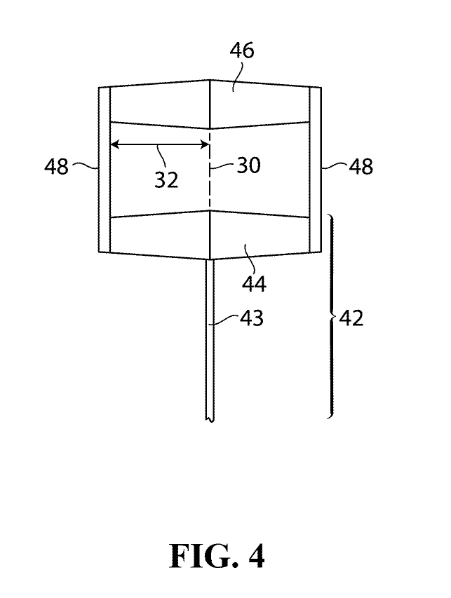

This type of arrangement is shown in FIG. 4, which illustrates another example video fader handle. In FIG. 4, an existing T-bar handle has a first hand grip portion 44 coupled to a shaft 43, and a second hand grip portion 46 is attached to the first hand grip portion 44 through extensions 48. In another embodiment only one extension 48 is provided.

Thus, with reference to FIGS. 2A, 2B, and 3, a lever handle for a video fader console could include an arm portion and a hand grip portion. The arm portion has a first section 28, which could be a shaft 43 of a T-bar handle 42, with a first end and a second end. The second end is to be coupled to the video fader console. A second section 24, which could include an extension 48 coupled to an end of a hand grip 44 of the T-bar handle 42, also has a first end and a second end. A third section 22, which could be part of the hand grip 44, has a first end coupled to the first end of the first section 28, 43 and a second end coupled to the second end of the second section 24, 48 to offset the first section and the second section out of alignment with each other.

The third section 22 (or part of 44) could orient the first section 28, 43 and the second section 24, 48 to extend in parallel directions and offset from each other in a direction perpendicular to the parallel directions, for example, as shown. The third section 22, 44 need not itself be oriented perpendicular to either or both of the first and section sections in order to offset them from each other in the perpendicular direction. In FIGS. 2A and 2B, for example, the third section 22 is non-perpendicular but still offsets the first and second sections 28, 24 from each other in a perpendicular direction as shown at 32. In FIG. 4 however, an axis of the hand grip portion 44, a part of which effectively forms the third section of the arm portion, is perpendicular to the first and second sections 43, 48.

It should also be noted that the various sections of an arm structure need not be perfectly straight. For example, any one or more of the sections could be curved or otherwise depart from being straight without affecting operation of a fader console handle. Even handle sections that are curved can be considered as extending in a direction. The sections 24, 28, for instance, could be curved and still extend in parallel directions and be offset from each other in a direction perpendicular to the parallel directions, or be offset out of alignment with each other.

The hand grip portion 20, 46 is coupled to the first end of the second section 24, 48, and the second section causes the hand grip portion to be oriented parallel to a surface of the video fader console in an embodiment, and offset from the third section 22, 44 in a direction away from the first section 28, 43. The hand grip portion 20, 46 can thus still be centrally located over the first section 28, 43, but the area under the hand grip portion is open and unobstructed by the arm portion. A multi-section arm structure also allows an ergonomic handle as disclosed herein to be used in conjunction with a central connection to a video fader console or module rotational mechanism, to avoid further modifications to the video fader console or mechanism to accommodate an ergonomic handle.

As noted above, a lever handle could include only one of the extensions 48 shown in FIG. 4, in which case the extension could be considered to be a form of the section 24 (FIGS. 2A and 2B, with one end coupled to an end of the hand grip 46 of the lever handle and an opposite end coupled to and end of the hand grip 44 of the T-bar handle 42. In the embodiment shown in FIG. 4, the second extension has two ends, respectively coupled to opposite ends of the hand grip portion 46 of the lever handle and the hand grip portion 44 of the T-bar handle 42.

The embodiment in FIG. 4 is an example of a retrofit embodiment, in which the first section is the shaft 43 of a T-bar handle 42, the third section is an existing hand grip portion 44 of the T-bar handle, and the second section comprises an extension 48 coupled to an end of the hand grip portion 44 of the T-bar handle.

FIG. 4 also illustrates an example of an embodiment in which a further arm section, in this case a second extension 48, is attached at a second end of the hand grip portion 46. One could consider the halves of the T-bar handle 44 to be two arm sections, both with one end coupled to the first end of the first section 43 and another end coupled to a respective one of the extensions 48.

Another possible retrofit option would be to remove the T-bar handle 44 and attach a separate arm section such as 22 between the shaft 43 and the extension 48. If the T-bar handle 44 were removed or the shaft 43 were cut off below the handle 44, then the section 28 could be coupled to the shaft 43, providing yet another option to retrofit an existing video fader console or module.

Further embodiments allow for adjustment of length of a video fader handle shaft. This facilitates shortening of the video fader handle when, for example, a video fader console is to be placed in storage on a shelf or in a case. Shortening of the video fader handle reduces the overall height of the video fader console, thereby reducing the storage area to accommodate the console. Such embodiments also allow the user to extend the handle shaft, giving the video fader handle a higher profile when not in storage. A higher profile might allow the fader handle to be more easily grasped, and also provides a longer throw, which could enable smoother and more precise control.

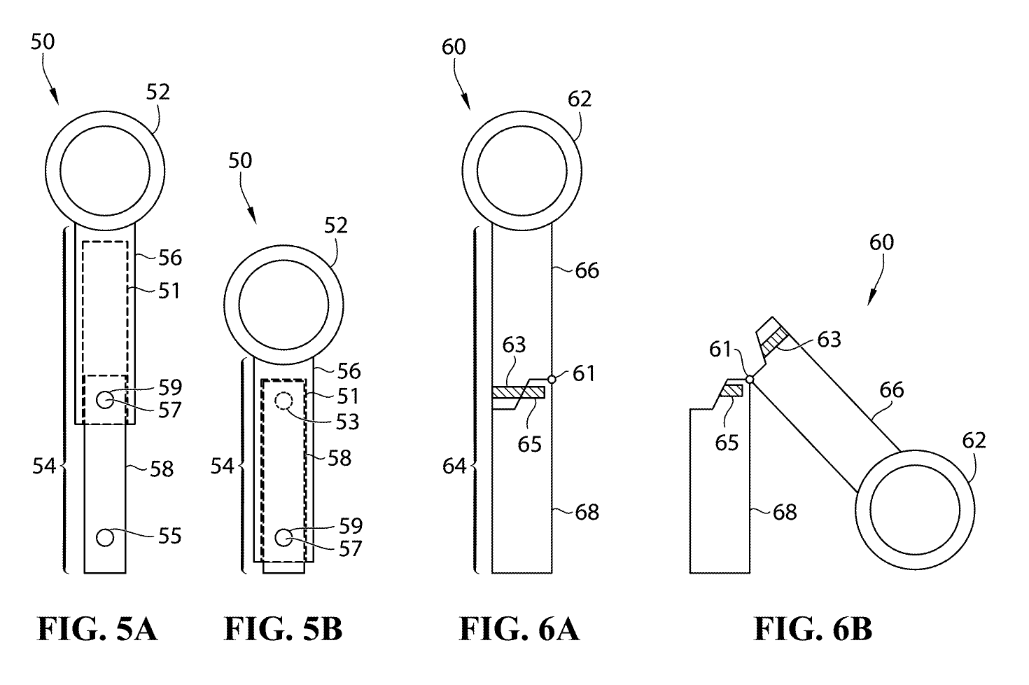

FIGS. 5A and 5B are plan views of an example video fader handle with a length adjuster. The example handle 50 shown in FIGS. 5A and 5B includes a hand grip 52 and a shaft 54 that includes a length adjuster. In the example shown, a telescoping mechanism is used to adjust the length of the shaft 54. Here, the shaft 54 includes two sections 56, 58, which interlock and slide longitudinally. One section 56 includes an internal cavity 51 into which the other section 58 is sized to fit. In other embodiments there could be more than two sections.

Two or more stops may be integrated into the sliding path, to lock the shaft sections 56, 58 at different positions, thereby composing different lengths of the shaft 54 and thus different overall lengths or heights of the handle 50. The stops may be secured, for example, by clips, pins, screws, or other mechanisms to securely hold the shaft assembly at the desired length. FIGS. 5A and 5B show an example in which a pin 57 is used in conjunction with bores 53, 55 in the shaft section 58 and a bore 59 in the shaft section 56 to lock the shaft in an extended position shown in FIG. 5A or a contracted position shown in FIG. 5B. The bore 59 is a through bore that passes through a wall of the shaft section 56. The bores 53, 55 may be through bores or only partially through the shaft section 58. In an embodiment, the bores 53, 55 are through bores, and through bores 59 are provided on opposite sides of the shaft section 56 so that the pin 57 passes entirely through both of the shaft sections 56, 58 to secure the shaft 54 in one of the two positions in the example shown in FIGS. 5A and 5B. A user can adjust the length of the shaft 54 in the example shown in FIGS. 5A and 5B by removing the pin 57, aligning the bore(s) 59 with one of the bores 53, 55, and inserting the pin.

In some embodiments, it may be possible to separate the sections 56, 58 of the shaft 54. This would allow the hand grip 52 and the shaft section 56 of the handle 50 to be completely removed, for example, in order to minimize the overall height of the handle. In the example handle 50, this could be accomplished by removing the pin 57 and pulling the hand grip 52 until the shaft section 56 is freed from the shaft section 58. This represents one example of a releasable attachment that could be used to implement a length adjuster. In the case of a releasable attachment implementation, there need not necessarily be more than one locking position. For example, in FIGS. 5A and 5B, the second bore 55 in the shaft section 58 need not be provided if the length adjustment is to be accomplished by removing the hand grip 50 and the shaft section 56 from the shaft section 58.

FIGS. 6A and 6B are plan views of another example video fader handle with a length adjuster. Like the example handle 50 in FIGS. 5A and 5B, the example handle 60 in FIGS. 6A and 6B includes a hand grip 62 and a shaft 64. The length adjuster in the example handle 60, however, includes a folding mechanism instead of a telescoping mechanism described above. The folding mechanism is implemented with a hinge 61 in the example shown. The hinge interconnects two shaft sections 66, 68, although in other embodiments there could be more than two shaft sections. In the example handle 60, the hinge 61 allows the fader handle shaft 64 to be folded in order to reduce the overall length of the shaft 64 and the overall height of the handle or a video fader console to which the handle is attached.

When the sections 66, 68 of the shaft 64 are unfolded, placing the shaft sections in straight alignment as shown in FIG. 6A, a locking mechanism may be employed to secure the shaft in this extended position. This locking mechanism may be implemented, for example, using clips, pins or screws. In FIGS. 6A and 6B, 63 and 65 represent bores or cavities into which a clip, pin, or screw could be inserted to secure the example handle 60 in the extended position shown in FIG. 6A. With the clip, pin, or screw removed, the example handle 60 is movable to the folded position shown in FIG. 6B.

A length adjuster could be provided in an ergonomic handle as disclosed herein or in a T-bar handle, for example. With reference to FIG. 2A for instance, the arm 14 could include a length adjuster, in one or more of the sections 22, 24, 28. A length adjuster has one position such as shown in FIGS. 5A and 6A, in which a handle arm that includes a length adjuster would have one length, and at least one other position such as shown in FIGS. 5B and 6B, in which the handle arm has a second length shorter than the first length. In the context of a video fader handle that is attached to a video fader console, these different lengths could equivalently be considered different heights of the handle above the surface of the video fader console, or different overall heights of the video fader console itself.

For embodiments in which length adjustment is to be implemented in a T-bar handle, a length adjuster could be provided in the handle shaft, such as in the handle shaft 43 of the T-bar handle 42 in FIG. 4. A length adjuster could be implemented in the shaft 43 of a T-bar handle that also includes one or both of the extensions 48 and the hand grip 46, or in a T-bar handle 42 without the extension(s) 48 or hand grip 46.

Thus, more generally, a lever handle for a video fader console could include an arm to be coupled to the video fader console, and a hand grip coupled to the arm. The arm includes a length adjuster, and the length adjuster has at least a first position in which the arm has a first length, and a second position in which the arm has a second length. The second length is shorter than the first length. Examples of a length adjuster include a telescoping mechanism, a releasable attachment, and a folding mechanism.

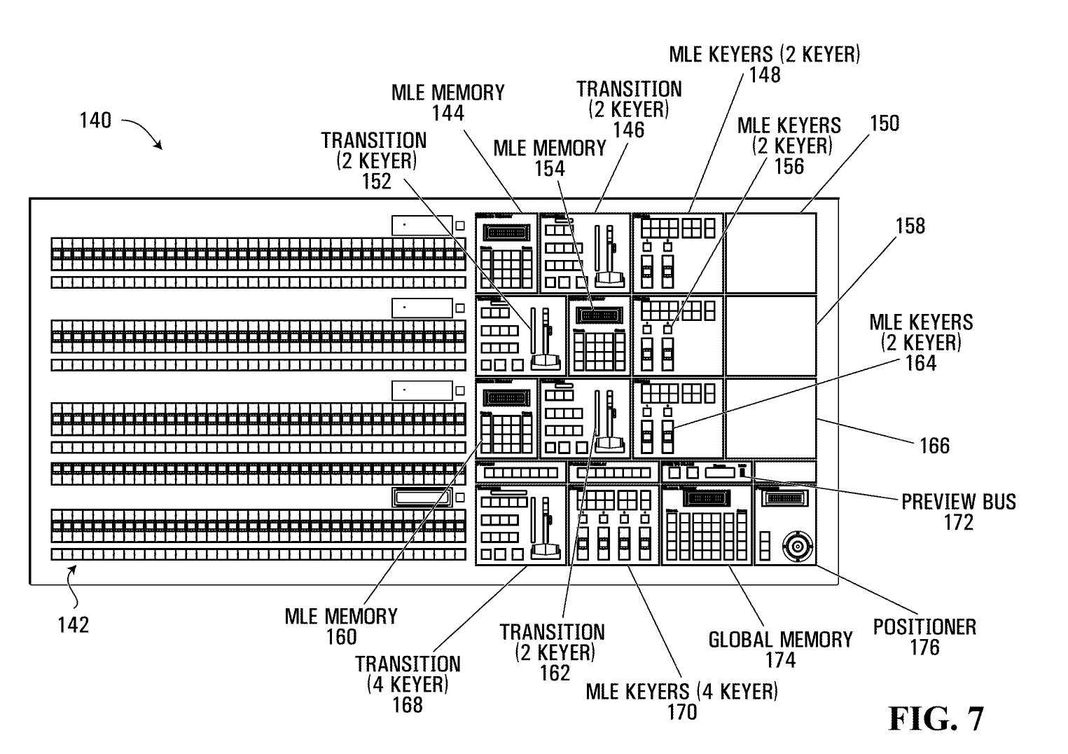

A fader console could be implemented, for example, in a video production switcher panel. A top view of an example video production switcher panel is shown in FIG. 7.

The example switcher panel 140 in FIG. 7 includes various modules, such as crosspoint button modules generally designated 142, ME (Multilevel Effects or Mix Effects) memory modules 144, 154, 160, two-keyer transition modules 146, 152, 162, two-keyer ME keyer modules 148, 156, 164, a four-keyer transition module 168, a four-keyer ME keyer module 170, a preview bus module 172, a global memory module 174, and a positioner module 176. Blanks which may be removed to accommodate additional modules are designated 150, 158, 166. Other embodiments may include further, fewer, or different modules arranged in a similar or different manner than shown. An ergonomic fader handle according to the present disclosure could be provided in or retrofitted onto any one or more of the transition modules 146, 152, 162, 168. Fader consoles, fader modules, and transition modules herein refer to the same type of component for controlling transitions between video frames or scenes.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the scope of an invention as defined in the appended claims.

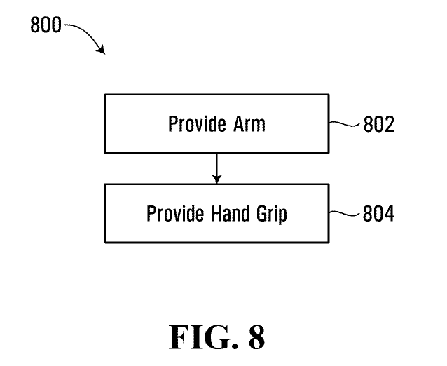

For example, there could be method embodiments. FIG. 8 is a flow diagram of an example method. In the example method 800, an arm for a video fader console lever handle is provided at 802, and a hand grip is provided at 804. These operations could be reversed in order in other embodiments.

The arm portion includes: a first section to be coupled to the video fader console; a second section to be coupled to the hand grip; and a third section coupled to the first section and to the second section. The third section offsets the first section out of alignment with the second section, and the hand grip is offset from the third section by the second section, in a direction away from the first section. In an embodiment, the third section orients the first section and the second section to extend in parallel directions and offset from each other in a direction perpendicular to the parallel directions, and the second section causes the hand grip to be oriented parallel to a surface of the video fader console and offset from the third section.

The arm could be provided as a one-piece structure as shown in FIGS. 1, 2A, and 2B, for example, or in two or more separate pieces that are subsequently coupled together. For example, providing the arm portion at 802 could involve providing the first section, the second section, and the third section; coupling a first end of the third section to a first end of the first section; and coupling a second end of the third section to a second end of the second section.

The hand grip could similarly be provided with the arm as a one-piece structure or separately. In an embodiment in which the arm and the handle are provided as separate components, a method could also include coupling the hand grip to the second section.

For a retrofit, providing the arm at 802 could involve providing the first section and the third section as a shaft and a hand grip portion, respectively, of a T-bar handle as shown in FIG. 4, and providing the second section as an extension coupled to an end of the hand grip of the T-bar handle.

Providing components as shown in FIG. 8 could involve manufacturing the components, or otherwise obtaining the components from a manufacturer. For example, a manufacturer of the components could “provide” the components by manufacturing them, whereas an entity building a video fader console handle and/or a video production switcher could “provide” the components by purchasing them from a manufacturer.

The method 800 is illustrative of an embodiment. Other embodiments could include additional operations. For example, there could be an operation of coupling a video fader handle to a video fader console or module or a to a component such as a rotational mechanism or assembly therein. This could in turn involve replacing an existing handle and/or coupling one or more extensions to an existing handle, for instance. Providing the arm at 802 could also or instead involve providing a length adjuster. Other possible method operations might be apparent, for example from the description of FIGS. 1 to 7 herein.

As noted above, handle arm sections could vary from being perfectly “straight” without substantially affecting handle operation. Similarly, the directions in which handle sections extend need not necessarily be perfectly parallel, and the offset between them need not necessarily be perfectly perpendicular to both directions of extension. Although angles between the third arm section and the first/second arm sections are expected to be right angles or greater, smaller angles could be used without affecting operation.

Embodiments of the present disclosure provide handles for a video fader console that may be easier to hold and therefore may allow for better control during operation. Embodiments in which a handle has a variable height or length are also disclosed, and may provide a lower-profile storage solution without restricting handle length or height.

What has been described is merely illustrative of the application of principles of embodiments of the present disclosure. Other variations could be or become apparent to and implemented by those skilled in the art.

What is claimed is:

1. A lever handle for a video fader console, the lever handle comprising:
a hand grip; and
an arm comprising:
a first section to be coupled to the video fader console;
a second section coupled to the hand grip; and
a third section coupled to the first section and to the second section to offset the first section out of alignment with the second section,
the hand grip being offset from the third section by the second section, in a direction away from the first section.

2. The lever handle of claim 1,
the first section comprising a first end and a second end, the second end to be coupled to the video fader console;
the second section comprising a first end and a second end, the first end coupled to the hand grip;
the third section comprising a first end coupled to the first end of the first section and a second end coupled to the second end of the second section to orient the first section and the second section to extend in parallel directions.

3. The lever handle of claim 1, the arm causing the hand grip to be oriented parallel to a surface of the video fader console.

4. The lever handle of claim 1, the hand grip being coupled to the second section by a fastener.

5. The lever handle of claim 1, the second section being perpendicular to the hand grip.

6. The lever handle of claim 1, the hand grip being adjustably positionable on opposite sides of the second section.

7. The lever handle of claim 1,
the first section comprising a shaft of a T-bar handle,
the third section comprising a hand grip of the T-bar handle,
the second section comprising an extension coupled to an end of the hand grip of the T-bar handle.

8. The lever handle of claim 7,
the hand grip of the lever handle having a first end and a second end,
the second section comprising a first end coupled to the first end of the hand grip of the lever handle, and a second end coupled to the end of the hand grip of the T-bar handle,
the hand grip of the T-bar handle having a second end,
the arm further comprising:
a second extension with a first end, coupled to the second end of the hand grip portion of the lever handle, and a second end, coupled to the second end of the hand grip portion of the T-bar handle.

9. The lever handle of claim 2,
the hand grip having a first end, coupled to the first end of the second section, and a second end,
the arm further comprising:
a fourth section with a first end, coupled to the second end of the hand grip, and a second end;
a fifth section with a first end coupled to the first end of the first section and a second end coupled to the second end of the fourth section.

10. The lever handle of claim 1, the third section further offsetting a center of the hand grip out of alignment with the first section.

11. The lever handle of claim 1,
the arm further comprising a length adjuster,
the length adjuster having at least a first position in which the arm has a first length, and a second position in which the arm has a second length, the second length being shorter than the first length.

12. The lever handle of claim 11, the length adjuster comprising one of: a telescoping mechanism, a releasable attachment, and a folding mechanism.

13. A video fader console comprising a lever handle as defined in claim 1.

14. A method comprising:
providing a hand grip for a video fader console lever handle;
providing an arm for the video fader console lever handle, the arm comprising:
a first section to be coupled to the video fader console;
a second section to be coupled to the hand grip; and
a third section coupled to the first section and to the second section to offset the first section out of alignment with the second section, the hand grip being offset from the third section by the second section, in a direction away from the first section.

15. The method of claim 14,
the first section comprising a first end and a second end, the second end to be coupled to the video fader console;
the second section comprising a first end to be coupled to the hand grip, and a second end;
the third section comprising a first end and a second end,
providing the arm portion comprising:
providing the first section, the second section, and the third section;
coupling the first end of the third section to the first end of the first section;
coupling the second end of the third section to the second end of the second section.

16. The method of claim 15, further comprising:
coupling the hand grip to the first end of the second section.

17. The method of claim 14,
providing an arm comprising providing at least one of the first section and the second section with a height adjuster.

18. A lever handle for a video fader console, the lever handle comprising:
an arm to be coupled to the video fader console;
a hand grip coupled to the arm;
the arm comprising a length adjuster, the length adjuster having at least a first position in which the arm has a first length, and a second position in which the arm has a second length, the second length being shorter than the first length.

19. The lever handle of claim 18, the height adjuster comprising a telescoping mechanism.

20. The lever handle of claim 18, the height adjuster comprising a releasable attachment.

21. The lever handle of claim 18, the height adjuster comprising a folding mechanism.
